(19) United States
(12) Patent Application Publication
(10) Pub. No.: US 2014/0072842 A1
(43) Pub. Date: Mar. 13, 2014

(54) CAPACITIVE BATTERY

(71) Applicant: Qiuming Liu, Shenzhen City (CN)

(72) Inventor: Qiuming Liu, Shenzhen City (CN)

(21) Appl. No.: 13/994,127

(22) PCT Filed: Sep. 11, 2012
(86) PCT No.: PCT/CN12/81236

§ 371 Date: Jun. 13, 2013

(51) Int. Cl. H01M 2/12

(52) U.S. Cl. CPC H01M 2/1288
USPC 429/54

(57) ABSTRACT

This invention relates to a capacitive battery including a battery shell formed with an opening at an end thereof, an electrolyte medium accommodated in the battery shell, a cover disposed at the opening of the battery shell for sealing the battery shell. The cover further has an elastically deformable decompression valve plate to reduce pressure impact generated by expansion of an inner of the battery shell. A lateral surface of the decompression valve plate contacts with the electrolyte medium and the other lateral surface of the decompression valve plate communicate outside. Besides, the decompression valve plate has an even thickness. The thickness of the decompression valve plate is within 0.1 mm to 2 mm. The thickness of the cover is no less than 4 mm. The cover of the capacitive battery has advantage of having good explosion-proof and leakproof function so as to improve safe use of the battery.

### TECHNICAL FIELD

The present invention relates to a technical field of a battery, and especially to a capacitive battery having an explosion-proof function.

### DESCRIPTION OF BACKGROUND

As shown in FIGS. 1 to 2, an existing capacitive battery includes an electrolyte medium 2 accommodated in a battery shell 1 and a cover 3′ for sealing the battery shell 1. The cover 3′ has a main body 30′ and an electrode hole 31′ for an electrode 4 to penetrate. Because the main body 30′ of the cover 3′ is a solid structure with a larger thickness h′, when a battery is used improperly and therefore under pressure because of expansion inside the battery, the battery tends to explode.

### SUMMARY

An object of the present invention is to provide a capacitive battery which cover has advantage of having good explosion-proof function so as to improve safe use of the battery.

To achieve the above objects, inventive embodiments of the present invention provides a capacitive battery comprising a battery shell formed with an opening at an end thereof, an electrolyte medium accommodated in the battery shell, a cover disposed at the opening of the battery shell for sealing the battery shell. The cover further comprises an elastically deformable decompression valve plate to reduce pressure impact generated by expansion of an inner of the battery shell. A lateral surface of the decompression valve plate contacts the electrolyte medium and the other lateral surface of the decompression valve plate communicates outside. The decompression valve plate has an even thickness.

According to one aspect of this invention, the cover is recessed from an outer end face thereof to form a trough. The decompression valve plate is formed at a bottom wall of the trough.

According to another aspect of this invention, the cover is recessed from an inner end face thereof toward an outer end face thereof to form a trough. The decompression valve plate is formed at a bottom wall of the trough.

According to another aspect of this invention, the thickness of the decompression valve plate is within 0.1 mm to 2 mm.

According to another aspect of this invention, the thickness of the cover is no less than 4 mm.

According to another aspect of this invention, the size and shape of the cover are fit with the opening of the battery shell. The cover and an inner wall of the opening of the battery shell snugly engage with each other.

According to another aspect of this invention, a sealing ring is provided on an outer wall of the cover.

According to another aspect of this invention, the battery shell is cylindrical with the opening. Correspondingly, the cover is cylindrical with the trough.

According to another aspect of this invention, an electrode hole is formed on the cover for an electrode to penetrate.

According to another aspect of this invention, the cover is made of an anti-corrosive elastic soft gel material.

Through the above-mentioned technical solution, the technical advantages of the embodiments of the present invention are described following. The inner end face of the capacitive battery is recessed inwardly to form the decompression valve plate for reducing pressure. The wall thickness of the decompression valve plate is within 0.1 mm to 2 mm. The decompression valve plate is elastically deformable which enable to reduce pressure, prevent battery explosion, and reinforce the usage security of the battery. In addition, the thickness of the cover is no less than 4 mm and the sealing ring configured on the cover snugly engaging with the inner wall of the battery; therefore, the cover has good leakproof function.

Embodiments of the present invention are further described in detail in cooperation with accompanying drawings as follows.

### DESCRIPTION OF THE DRAWINGS

FIG. 1 is a cross-sectional view of a conventional capacitive battery.

FIG. 2 is a cross-sectional view of a cover of the conventional capacitive battery.

FIG. 3 is a cross-sectional view of a capacitive battery in accordance with a first embodiment of the present invention.

FIG. 4 is an elevational view of a cover of the capacitive battery in accordance with the first embodiment of the present invention.

FIG. 5 is a cross-sectional view of the cover of the capacitive battery in accordance with the first embodiment of the present invention.

### DETAILED DESCRIPTION OF THE EMBODIMENTS

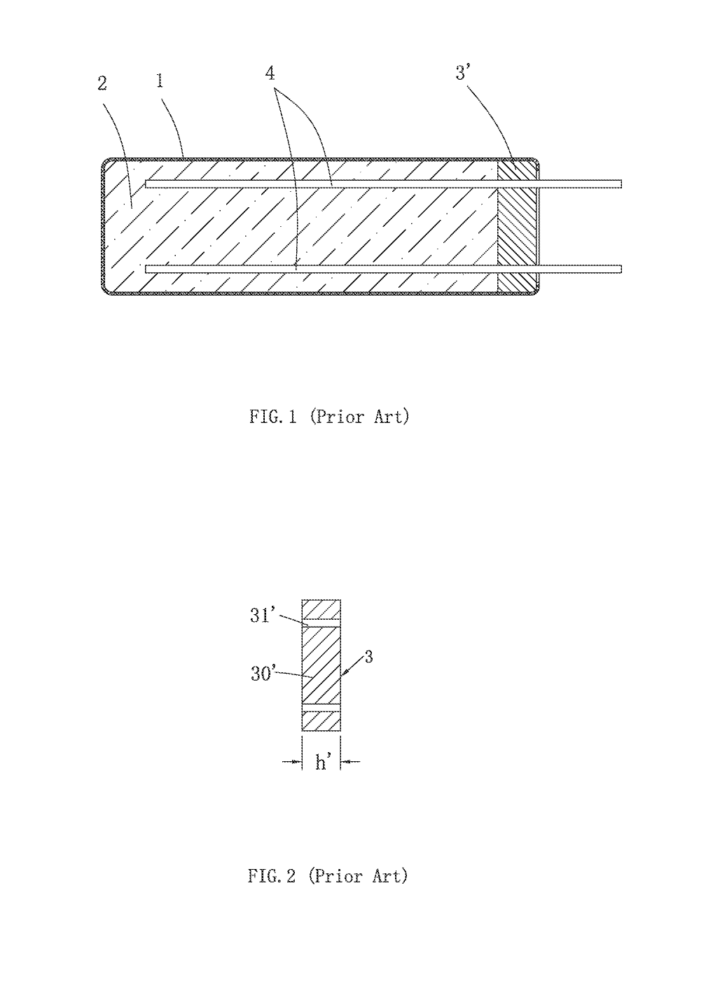

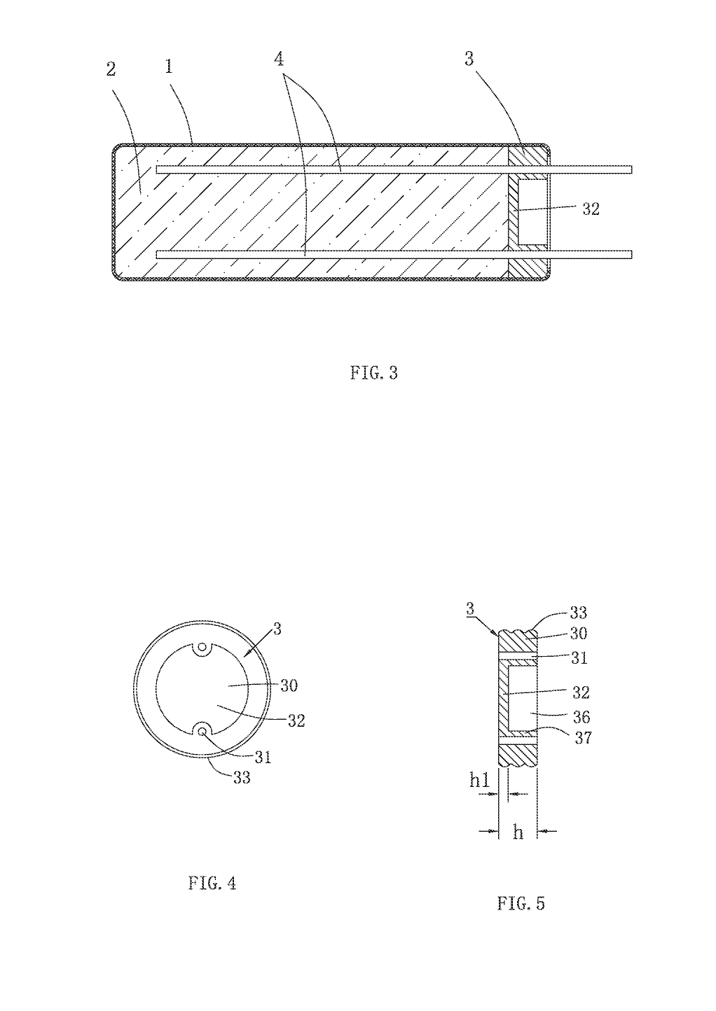

As shown in FIGS. 1-5, a capacitive battery is provided in accordance with an embodiment of the present invention. The capacitive battery comprises an electrolyte medium 2 accommodated in a battery shell 1, a cover 3, and an electrode 4.

The battery shell 1 accommodates the electrolyte medium 2. The battery shell 1 is hollow cylindrical with an opening at an end. In this embodiment, the battery shell 1 is a cylindrical casing.

The cover 3 is disposed at the opening of the battery shell 1 for sealing the battery shell 1 and snugly engages with an inner wall of the opening of the battery shell 1. The cover 3 comprises a main body 30, an electrode hole 31 for an electrode 4 to penetrate, a decompression valve plate 32 formed in the main body 30 to reduce pressure impact, and a sealing ring 33. The main body 30 is made of an anti-corrosive elastic soft gel material, such as silica gel material. In this embodiment, the cover 3 is cylindrical. Certainly, the shape of the cover 3 is not limited to be cylindrical as long as the shape thereof matches the battery shell 1. A thickness h of the main body 30 is no less than 4 mm so as to prevent the electrolyte medium 2 leaking out of the battery shell 1. The main body 30 is recessed from an outer end face thereof to an inner or from an inner end face thereof to the outer end face to form a trough 36. The decompression valve plate 32 is formed at a bottom wall of the trough 36. The decompression valve plate 32 has an even thickness h1 which is within 0.1 mm to 2 mm so as to enable the decompression valve plate 32 to be elastically deformable and to return to a previous position automatically. A sidewall 37 of the trough 36 is provided with an electrode hole 31 penetrating the cover 3 in an axial direction of the cover 3. In this embodiment, the cover 3 is substantially cylindrical with the trough 36. A lateral surface of the decompression valve plate 32 of the cover 3 contacts the electrolyte medium 2, and the other lateral surface communicates outside. That is, an opening of the trough 36 faces outside of the battery shell 1 for reducing pressure impact. The sealing ring 33 is disposed on an outer wall of the cover 3. The cover 3 seals the electrolyte medium 2 in the battery shell 1 through the sealing ring 33 being snug against an inner wall of the battery shell 1. Therefore, the cover 3 has good sealing and leakage proof performances.

There are two the electrodes 4 which are a positive electrode and a negative electrode. The two electrodes 4 are inserted into the battery shell 1 and penetrate the electrode holes 31 of the cover then extend to outside of the cover 3.

Since the decompression valve plate 32 has an even thickness and is elastically deformable, the decompression valve plate 32 enables to elastically deform so as to reduce pressure and prevent the battery from explosion when a battery is used improperly and bulges therein causing pressure inside the battery, whereby improving safe use of the battery.

The above mentioned is only exemplary embodiments of the present invention. It is required to explain that, without any confliction, embodiments of the present invention and features thereof can be combined. It should be noted, for persons of ordinary skill in this art field, improvements and modifications within the spirit of the present invention can be further made, and such improvements and modifications should be seemed to be included in the claimed scope of the present invention.

1. A capacitive battery, comprising a battery shell formed with an opening at an end thereof, an electrolyte medium accommodated in the battery shell, a cover disposed at the opening of the battery shell for sealing the battery shell, wherein the cover further comprises an elastically deformable decompression valve plate to reduce pressure impact generated by expansion of an inner of the battery shell, a lateral surface of the decompression valve plate contacting the electrolyte medium, the other lateral surface of the decompression valve plate communicating outside and the decompression valve plate having an even thickness.

2. The capacitive battery as claimed in claim 1, wherein the cover is recessed from an outer end face thereof to form a trough, and the decompression valve plate is formed at a bottom wall of the trough.

3. The capacitive battery as claimed in claim 1, wherein the cover is recessed from an inner end face thereof toward an outer end face thereof to form a trough, and the decompression valve plate is formed at a bottom wall of the trough.

4. The capacitive battery as claimed in claim 1, wherein the thickness of the decompression valve plate is within 0.1 mm to 2 mm.

5. The capacitive battery as claimed in claim 1, wherein the thickness of the cover is no less than 4 mm.

6. The capacitive battery as claimed in claim 1, wherein the size and shape of the cover are fit with the opening of the battery shell, and the cover and an inner wall of the opening of the battery shell are snugly engaging with each other.

7. The capacitive battery as claimed in claim 6, wherein a sealing ring is provided on an outer wall of the cover.

8. The capacitive battery as claimed in claim 6, wherein the battery shell is cylindrical with the opening, and correspondingly the cover is cylindrical with the trough.

9. The capacitive battery as claimed in claim 1, wherein at least one electrode hole is formed on the cover for an electrode to penetrate.

10. The capacitive battery as claimed in claim 1, wherein the cover is made of an anti-corrosive elastic soft gel material.
